(19) United States
(12) Patent Application Publication
(10) Pub. No.: US 2008/0276762 A1
(43) Pub. Date: Nov. 13, 2008

(54) Torque transmission mechanism

(75) Inventor: Kevin Arthur Dein, Dubbo (AU)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Xact-Design & Engineering Pty Ltd, Dubbo (AU)

(21) Appl. No.: 12/070,274

(22) Filed: Feb. 14, 2008

Related U.S. Application Data
(63) Continuation of application No. 10/524,799, filed on Aug. 26, 2005, now abandoned.

(30) Foreign Application Priority Data
Aug. 21, 2002 (AU) 2002950913
Feb. 26, 2003 (AU) 2003900881
Feb. 26, 2003 (GB) 0304380.9

(51) Int. Cl. B25B 23/157; B25B 13/00

(52) U.S. Cl. 81/59.1; 192/44

(57) ABSTRACT

A torque transmission mechanism comprises an outer body defining a cavity and an inner body located at least partially inside the cavity and able to rotate therein. A plurality of rollers located between the outer and inner bodies interact with cam surfaces so that rotation of the inner body in a first direction is substantially unimpeded but rotation in the opposite direction is prevented or impeded by interaction of rollers with one or more cam surfaces. One of the rollers is larger than at least one other roller and is located in a recess formed in one of the outer and inner bodies. In one embodiment the recess is formed in a part of the outer body which has a greater wall thickness, excluding the effect of the recess than the rest of the outer body, so that the larger roller is accommodated without adding bulk to the outer body.

### CROSS-REFERENCE TO RELATED APPLICATIONS

This application is a continuation of U.S. application Ser. No. 10/524,799, filed on Aug. 26, 2005, the disclosure of which is incorporated herein by reference.

### FIELD OF THE INVENTION

The present invention relates to a torque transmission mechanism and especially, but not exclusively, to a torque transmission mechanism for use in a hand tool such as a socket wrench. A hand tool is also provided.

### BACKGROUND OF THE INVENTION

Torque transmission mechanisms for selectively transmitting torque between an outer body and an inner body are known. In some known mechanisms, the bodies are free to rotate relative to each other in a first direction but not free to rotate relative to each other in the opposite direction. One commercially common form of such a device is embodied in the ratchet wrench of a socket set, which includes a ratchet and pawl mechanism. However, because such devices typically include a maximum of only about 72 ratchet teeth, the inner and outer bodies may move relative to each other by up to about 5 degrees in the direction in which there is intended to be no relative rotation before a ratchet tooth is fully engaged by a pawl, and the inner and outer bodies are rotationally coupled. This leads to inefficiency, since a few degrees of rotation are lost on each stroke, and under circumstances in which the handle can only be moved by a few degrees (because of lack of space to move a handle more than a few degrees) may even lead to complete inability to operate the tool. Furthermore, ratchet socket wrenches are subject to considerable wear and when used intensively may have a useful life of only a few months. Failure may be costly and may cause injury to the operator.

Despite these disadvantages, tools using other mechanisms to allow relative rotation between the inner and outer bodies do not appear to have become commercially successful. One possible reason for this is that it is difficult to reconcile commercially important considerations which tend to dictate that the number of moving parts should be minimised, practical considerations which dictate that the size of the tool head should be small and functional considerations which favour robust construction and improved distribution of the load in order to avoid damage to or failure of the tool.

### DESCRIPTION OF THE INVENTION

According to a first aspect of the present invention, there is provided a torque transmission mechanism comprising:

an outer body having an inner surface defining a cavity therein;

an inner body having an outer surface, the inner body being located at least partially inside the cavity and able, in use, to rotate therein;

a plurality of rollers each located between the outer body and the inner body;

wherein there is provided one or more cam surfaces;

wherein rotation of the inner body relative to the outer body in a first direction is substantially unimpeded by the rollers, but rotation of the inner body in the opposite second direction is prevented or impeded by interaction of at least two rollers with said one or more cam surfaces;

wherein one of the rollers which interact with the one or more cam surfaces is a larger roller which is of a larger diameter than at least one other smaller roller which interacts with one of the one or more cam surfaces;

wherein one of the outer body and the inner body is formed with a recess therein, and the larger roller is located in said recess; and

wherein the body in which the recess is formed has a shape which, excluding the effect of the recess, has a non-uniform wall thickness, and the part of the body in which the recess is formed includes a part with a greater wall thickness excluding the effect of the recess.

The non-uniform wall thickness may be provided in order to allow the body to perform a specific function other than including the recess.

Preferably, the recess is formed in the outer body.

Preferably, said larger roller has a diameter at least approximately fifty percent greater than the diameter of said at least one smaller roller.

Said larger roller may have a diameter of approximately double the diameter of said at least one smaller roller.

Preferably, the torque transmission mechanism is included in a tool, wherein the outer body forms part of a tool head and the part of the outer body with the greater wall thickness is a part which, in use, is intermediate the inner body and a handle of the tool.

Preferably, said recess includes a wider portion and a narrower portion, said wider and narrower portions being defined by a cam surface.

Preferably, the body in which the recess is formed includes one or more other recesses in which one or more rollers other than the larger roller is/are located.

Preferably, at least one roller located in a recess is resiliently biased toward the narrow portion of the recess.

At least one of the rollers may be substantially cylindrical.

At least one of the rollers may be generally spherical.

Preferably, at least one roller serves to locate the inner body relative to the outer body.

Preferably, the torque transmission mechanism includes at least three rollers.

Preferably, at least one of the inner body and the outer body includes an attachment and/or engagement portion for attachment to or engagement with an element to be driven.

Preferably, the inner body includes a central cavity or aperture for complementary receipt of an element to be driven. Said element to be driven may be a drive element. In some embodiments the drive element is a drive block for connection to a socket. Alternatively, said element to be driven may be a fastener. In some embodiments the inner body may engage nuts or bolt heads directly.

Preferably, the central cavity is square in radial cross-section for complementary receipt of a square cross-section drive element. In alternative embodiments, other cross-sectional shapes such as, but not limited to, octagonal or hexagonal, of bore could be provided for complementary receipt of correspondingly shaped drive elements.

Preferably, the cavity is in the form of a bore which extends through the inner body.

Preferably, the rotation of the inner body in the second direction is prevented or impeded by interaction of at least three generally cylindrical rollers, each with a respective cam surface.

Preferably, in addition to said cylindrical rollers there is provided one or more generally spherical rollers one or more of which prevents or impedes rotation of the inner body in the second direction by interaction with a cam surface.

Preferably, at least one generally spherical roller acts to support the inner body in a desired position within the outer body.

Preferably, at least one cam surface which interacts with a given roller includes an arcuate portion with a radius of curvature approximately the same as the radius of the given roller.

Preferably, the given roller interacts with the arcuate portion of the cam surface so that an arcuate portion of the roller contacts the arcuate portion of the cam surface.

Preferably, the given roller acts as a stop.

Preferably, in use, the proportion of the circumference of the given roller which contacts the arcuate cam surface is greater than the proportion of the rollers which do not interact with such arcuate cam portions. This may provide enhanced load-bearing characteristics for the given roller in its interaction with the corresponding cam surface.

Said given roller is preferably a generally spherical roller. In this case, the arcuate cam portion may have a concave part-spherical portion for interaction with the spherical roller.

Preferably, the inner body is supported in the cavity by three or more rollers.

According to a second aspect of the present invention, there is provided a tool including a head wherein the head includes or consists of a torque transmission mechanism in accordance with a first aspect of the present invention.

Preferably, the tool includes, in use, a handle coupled to the head.

Preferably, the recess is located in a part of the outer body which, in use, is generally intermediate the inner body and the handle of the tool.

Preferably, the inner body includes a central bore for complementary receipt of a drive element, so that in use said drive element may be driven by application of a force to the handle of the tool.

Preferably, the tool includes a bore for complementary receipt of a drive element, so that the tool may be driven by a force applied to said drive element.

According to a third aspect of the present invention, there is provided a tool including a one-way torque transmission mechanism in a head thereof, which in use imparts torque from a driving portion to a drive element thereof, wherein said tool includes an attachment portion for attachment of a drive element of another tool, so that the drive element of the other tool may be forced so as to impart torque to the drive element of said tool.

Preferably, said tool has a handle portion and the attachment portion is located generally between the head and the handle portion thereof.

Preferably, said tool is a socket wrench.

Preferably, said attachment portion comprises a cavity for receipt of a drive element of said other tool.

Preferably, the cavity has a cross-sectional shape corresponding to the shape of a regular polygon.

Preferably, the cavity is square in radial cross-section for receipt of a square cross-section drive element.

Preferably, the cavity is in the form of a bore which extends through a portion of the tool.

The tool may include a plurality of attachment portions.

Said other tool may be a torque wrench.

Said other tool may be an extension handle.

According to a fourth aspect of the present invention, there is provided a torque transmission mechanism comprising:

an outer body having a cavity therein; an inner body located at least partially within the cavity;

a mechanism for controlling relative rotation of the inner body and outer body so that, in use, rotation of the inner body relative to the outer body in the first direction may be substantially unimpeded, but rotation of the inner body relative to the outer body in the opposite second direction is prevented or impeded;

wherein a cover is provided which extends between the inner body and the outer body, said cover being, in use, substantially fixed relative to the outer body; and

wherein one or more seals are provided between the inner body and the cover so as to isolate the mechanism for controlling relative rotation of the inner body and the outer body, from the exterior of the tool.

Preferably, the one or more seals includes at least one ‘O’ ring.

According to a fifth aspect of the present invention, there is provided a torque transmission mechanism comprising:

an outer body having an inner surface defining a cavity therein;

an inner body having an outer surface, the inner body being located at least partially inside the cavity and able, in use, to rotate therein;

a plurality of rollers each located between the outer body and the inner body;

wherein there is provided one or more cam surfaces;

wherein rotation of the inner body relative to the outer body in a first direction is substantially unimpeded by the rollers, but rotation of the inner body in the opposite second direction is prevented or impeded by interaction of at least two rollers with said one or more cam surfaces;

wherein at least one of the rollers which interact with the one or more cam surfaces is a larger roller which is of a larger diameter than at least one other smaller roller which interacts with one of the one or more cam surfaces;

wherein the interaction of the rollers with the cam surface(s) which corresponds to prevention or impeding of the rotation in the second direction corresponds to each of the rollers being forcibly engaged between the inner and outer bodies so as to transmit torque between said inner and outer bodies; and

wherein as the mechanism changes from a state in which the rollers are not forcibly engaged between the inner and outer bodies to a state in which the rollers are forcibly engaged between the inner and out bodies, the rollers do not all become forcibly engaged between the inner and outer bodies simultaneously.

Preferably, in use, one or more smaller rollers become forcibly engaged before one or more larger rollers.

According to a sixth aspect of the present invention, there is provided a tool including a head, wherein the head includes or consists of a torque transmission mechanism comprising:

an outer body having an inner surface defining a cavity therein;

an inner body having an outer surface, the inner body being located at least partially inside the cavity and able, in use, to rotate therein;

a plurality of rollers each located between the outer body and the inner body;

wherein rotation of the inner body relative to the outer body in a first direction is substantially unimpeded by the rollers, but rotation of the inner body in the opposite second direction is prevented or impeded by interaction of at least two rollers with the inner and outer bodies; and

wherein at least one of the rollers has a larger diameter than at least one other roller.

Preferably, the interaction of the at least two rollers with the inner and outer bodies includes interaction of said rollers with cam surfaces provided in the tool head.

Preferably, at least one cam surface which interacts with a given roller includes an arcuate portion with a radius of curvature approximately the same as the radius of the given roller.

Preferably, the given roller interacts with the arcuate portion of the cam surface so that an arcuate portion of the roller contacts the arcuate portion of the cam surface.

Preferably, the given roller acts as a stop.

Preferably, in use, the proportion of the circumference of the given roller which contacts the arcuate cam surface is greater than the proportion of the rollers which do not interact with such arcuate cam portions. This may provide enhanced load-bearing characteristics for the given roller in its interaction with the corresponding cam surface.

Said given roller may be a generally spherical roller. In this case, the arcuate cam portion may have a concave part spherical portion for interaction with the spherical roller.

According to a seventh aspect of the present invention, there is provided a torque transmission mechanism comprising:

an outer body having an inner surface defining a cavity therein;

an inner body having an outer surface, the inner body being located at least partially inside the cavity and able, in use, to rotate therein;

a plurality of rollers each located between the outer body and the inner body;

wherein rotation of the inner body relative to the outer body in a first direction is substantially unimpeded by the rollers, but rotation of the inner body in the opposite second direction is prevented or impeded by interaction of at least two rollers with the inner and outer bodies; and

wherein at least one of the rollers is generally spherical.

Preferably, the interaction of the at least two rollers with the inner and outer bodies includes interaction of said rollers with cam surfaces provided in the inner and/or outer bodies.

Preferably, at least one cam surface which interacts with a generally spherical roller includes an arcuate portion with a radius of curvature approximately the same as the radius of the spherical roller.

Preferably, the given roller interacts with the arcuate portion of the cam surface so that an arcuate portion of the roller contacts the arcuate portion of the cam surface.

Preferably, the spherical roller acts as a stop.

Preferably, the mechanism includes at least one cylindrical roller which contacts a cam surface and, in use, the proportion of the surface of the spherical roller which contacts the arcuate cam surface is greater than the proportion of the cylindrical roller(s) which contact respective cam surface(s).

Preferably, the arcuate cam portion has a concave part-spherical shape for interaction with the spherical roller.

Preferably, the mechanism is included in the head of a tool. The tool may be a socket wrench.

According to an eighth aspect of the present invention, there is provided a torque transmission mechanism comprising:

an outer body having an inner surface defining a cavity therein;

an inner body having an outer surface, the inner body being located at least partially inside the cavity and able, in use, to rotate therein;

a plurality of rollers each located between the outer body and the inner body;

wherein there is provided one or more cam surfaces;

wherein rotation of the inner body relative to the outer body in a first direction is substantially unimpeded by the rollers, but rotation of the inner body in the opposite second direction is prevented or impeded by interaction of at least one interaction member with at least one of said one or more cam surfaces; and

wherein at least that portion of a cam surface with which said at least one interaction member interacts is substantially straight.

Preferably, the at least one interaction member is a roller.

Preferably, the at least one interaction member is generally cylindrical.

Preferably, said substantially straight cam surface portion is provided on said outer body.

Preferably, said substantially straight cam surface portion is provided on an inner surface of a recess in which said at least one interaction member is retained in use.

Preferably, said recess is adapted to retain a plurality of interaction members, which can interact with respective cam surfaces provided on an inner surface of the recess in order to prevent or impede rotation of the inner body relative to the outer body.

Preferably, at least two of the respective cam surfaces include portions which are substantially straight and which can interact in use with respective interaction members.

Preferably, at least two of the interaction members retained in the cavity are of different sizes.

Preferably, the inner surface of the recess includes a step portion between the substantially straight cam surfaces.

Preferably, there are provided two or more recesses each including a substantially straight cam portion.

Preferably, each recess includes at least two substantially straight cam portions, each of which is adapted to interact with a different interaction members.

Preferably, the or each recess is provided in the outer body.

Preferably, the respective interaction members are adapted to be clamped between the outer surface of the inner body and respective cam surfaces in order to prevent or impede relative rotation of the inner and outer bodies.

Preferably, the portion of the outer surface of the inner body which can, in use, interact with the interaction member(s) is arcuate.

Preferably, the outer surface portion is generally circular.

Preferably, the outer surface portion is generally cylindrical.

According to a ninth aspect of the present invention, there is provided a torque transmission mechanism comprising:

an outer body having an inner surface defining a cavity therein;

an inner body having an outer surface, the inner body being located at least partially inside the cavity and able, in use, to rotate therein;

at least one location member for relatively locating the outer body and the inner body;

wherein there is provided one or more cam surfaces;

wherein rotation of the inner body relative to the outer body in a first direction is substantially unimpeded by the at least one location member, but rotation of the inner body in the opposite second direction is prevented or impeded by interaction of at least one interaction member with said one or more cam surfaces; and

wherein the at least one location member is unable to interact with a cam surface, and serves solely to support and locate the inner body in the outer body, without substantially impeding relative rotation of the inner and outer bodies.

Preferably, the at least one location member is a roller located between the inner body and the outer body.

Preferably, there are provided at least three rollers which are unable to interact with a cam surface.

Preferably, each of the one or more rollers which is unable to interact with a cam surface is retained in a recess provided in the outer body.

Each of the one or more rollers unable to interact with a cam surface may include a generally cylindrical rolling surface.

Alternatively, each of the one or more rollers unable to interact with a cam surface may be generally spherical.

Preferably, there are sufficient location members that they would be able to effectively support and locate the inner and outer bodies even in the absence of the interaction members.

In at least preferred embodiments of mechanisms in accordance with this aspect, the use of rollers which support the inner body relative to the outer body, but which do not act as interaction members which serve to impede or prevent relative rotation of the inner and outer bodies, provides especially low friction rotation of the inner body relative to the outer body in the first direction.

According to a tenth aspect of the present invention, there is provided:

a tool for interaction with a polygonal fastener having a number of edges;

wherein the tool has an open fastener receiving portion including a number of internal surface portions adapted for interaction with corresponding edges of the fastener; and

wherein the internal surface portions are adapted to fit closely to more than half of the edges of the fastener.

Preferably, the tool is a spanner.

Preferably, the tool is adapted for use with hexagonal nuts and/or bolt-heads.

Preferably, the tool provides four internal surface portions adapted to interact with four edges of a hexagonal nut or bolt-head.

According to an eleventh aspect of the present invention, there is provided a mechanism for transmitting torque from a hand tool for applying torque to fasteners, to a fastener, said mechanism including:

a hand tool interaction portion for engagement with a portion of the hand tool which is adapted to contact with and to drive a fastener;

a driving portion for driving a fastener; and

a securing portion for releaseably attaching to the fastener interaction portion, for securing the fastener interaction portion in relation to the portion of the hand tool which is adapted for contact with and to drive a fastener.

Preferably, the mechanism is for transmitting torque from a ring spanner to a fastener.

Preferably, the driving portion is adapted to engage a fastener.

Preferably, the driving portion is adapted to engage a nut or bolt-head.

Preferably, the hand tool interaction portion and the driving portion are formed as a single member.

Preferably, the mechanism includes a through bore extending axially therethrough.

Preferably, the hand tool interaction portion is generally hexagonal in radial cross-section.

Preferably, the hand tool interaction includes a connection portion for cooperative connection to a corresponding connection portion of the securing portion.

Preferably, the connection portion of one of the hand tool interaction portion and the securing portion includes a biased connection element for cooperation with an associated recess on the other of the hand tool interaction portion and the securing portion.

It will be appreciated that two or more aspects of the present invention may be beneficially combined, and that certain features which are preferably or optionally incorporated in respect of one aspect may also be preferably or optionally incorporated in embodiments of other aspects.

### BRIEF DESCRIPTION OF THE DRAWINGS

Preferred embodiments of aspects of the present invention will now be described, by way of example only, with reference to the accompanying drawings in which:

FIG. 1 is a schematic plan part-sectional view of an embodiment of a torque transmission mechanism incorporated in the head of a socket wrench;

FIG. 2 is a greatly enlarged schematic representation of a clutch roller in a recess in the embodiment of FIG. 1;

FIG. 3a is a plan view of an embodiment of a socket wrench including a torque transmission mechanism in accordance with one or more aspects of the present invention; and

FIG. 3b is a partial cross-sectional side view corresponding to FIG. 3a;

FIG. 4 is a schematic plan part-sectional view of an embodiment similar to the embodiment of FIG. 1 but including a seal;

FIG. 5 is a schematic plan part-sectional view of an alternative embodiment;

FIGS. 6a, 6b, 6c, 6d and 6e are plan views of alternative embodiments of tools, each with a corresponding end projection;

FIGS. 7a, 7b, 7c and 7d are plan views of further alternative embodiments;

FIGS. 8a and 8b are plan views of alternative embodiments of tool heads;

FIG. 9a is a plan view of an alternative embodiment of a tool;

FIG. 9b is a side view of the tool of FIG. 9a;

FIGS. 10a and 10b are illustrations of tool handles suitable for use with the embodiments of FIGS. 5 to 8b;

FIG. 11a is a plan view of a conventional ring spanner;

FIGS. 11b, 11c and 11d are partial sectional views of the heads of embodiments of ring spanners in accordance with one or more aspects of the present invention;

FIG. 12a is a side, partial cross-sectional view of a further embodiment of a tool in accordance with one or more aspects of the present invention in the form, of a socket type tool;

FIG. 12b is an end view of a part of the tool of FIG. 12a;

FIGS. 13 and 14 are schematic partial sectional views showing alternative roller configurations for the tool of FIGS. 12a and 12b.

FIGS. 15a, 15b, 15c and 15d are, respectively, plan, side perspective and end views of a further embodiment of a socket wrench tool;

FIGS. 15e and 15f are, respectively, cross-sectional views on A-A of FIG. 15a and B-B of FIG. 15b respectively;

FIG. 16a is an enlarged detail of part of FIG. 15f;

FIG. 16b provides three views of an element of FIG. 16a;

FIG. 17a is a plan view of an embodiment of a combination spanner including an attached two-part socket mechanism;

FIG. 17b is a side elevation corresponding to FIG. 17a and showing some internal detail;

FIG. 17c is a perspective view corresponding to FIG. 17a;

FIG. 17d is a perspective view corresponding to FIG. 17c but showing the parts of the socket mechanism and combination spanner separated;

FIG. 17e is a cross-section corresponding to A-A of FIG. 17b;

FIG. 17f is a cross-section corresponding to B-B of FIG. 17a;

FIG. 17g is an end view corresponding to FIGS. 17a, 17b and 17c;

FIG. 17h is an enlarged detail of FIG. 17f;

FIG. 18 is an enlarged detail of FIG. 17e;

FIGS. 19a and 19b are enlarged details of FIGS. 17c and 17d; and

FIG. 20 is an enlargement of FIG. 17f.

### DETAILED DESCRIPTION OF THE PREFERRED EMBODIMENTS

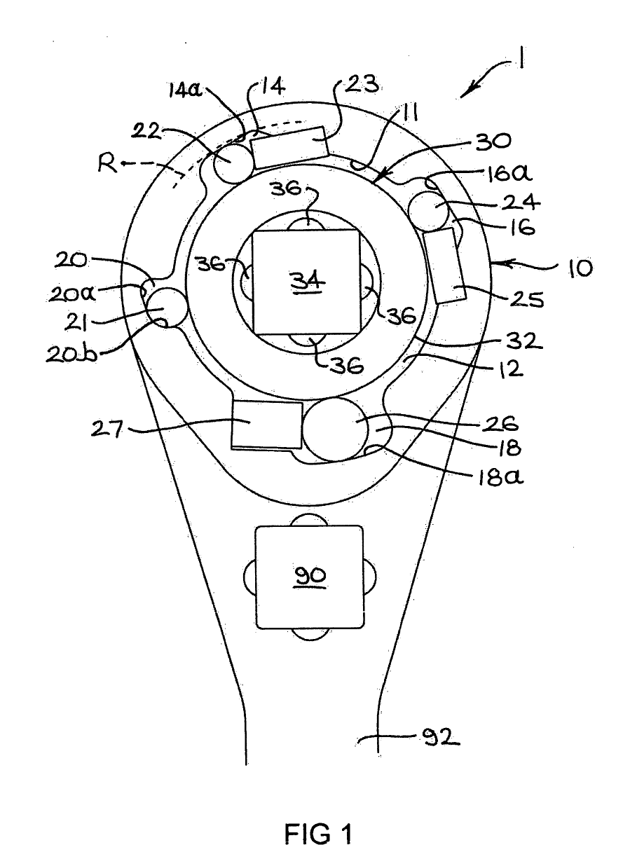

Referring, now to FIG. 1, a preferred embodiment of a torque transmission mechanism in accordance with aspects of the present invention, generally designated 1, incorporated in a tool, includes a hollow outer body 10 and a generally cylindrical inner body 30 accommodated inside a cavity 12 provided in the outer body 10. The inner body has a generally cylindrical outer surface 32.

The cavity 12 is defined by an inner wall 11 of the outer body 10. The cavity 12 may be considered generally cylindrical in shape and, in use, generally coaxial with the inner body 30. First to third circumferentially extending recesses 14, 16, 18 are formed on the inner wall 11 of the outer body 10. The recesses 14, 16, 18 are defined by generally radially extending wall portions of the wall 11 which define the ends of the recesses and generally circumferentially extending cam surfaces 14a, 16a, 18a, which define the widths, or radial sizes, of the recesses, ie the circumferentially varying spacing between the respective cam surfaces 14a, 16a, 18a and the outer surface 32 of the inner body 30.

Although the cam surfaces 14a, 16a, 18a extend generally circumferentially, they are not exactly circumferential in orientation. Each of the first to third recesses 14, 16, 18 has a narrower portion at a circumferentially more anti-clockwise part thereof (as viewed in FIG. 1) and a wider portion at a circumferentially more clockwise part thereof (as viewed in FIG. 1). The varying widths of the recesses are determined by the difference between the actual geometries of the cam surfaces 14a, 16a, 18a and a nominal truly circumferential surface. In order to illustrate this clearly, FIG. 1 includes, adjacent the cam surface 14a of the first recess 14, an arcuate broken curve, designated R, which has as its centre of curvature the axis of the inner body 30. A comparison between curve R and the cam surface 14a clearly illustrates the geometry of the cam surface 14a and the varying width of the recess 14.

The first to third circumferentially extending recesses 14, 16, 18 house respective first to third generally cylindrical rollers 22, 24, 26, and associated first to third helical springs 23, 25, 27. The first to third helical springs 23, 25, 27, abut the clockwise ends of the respective recesses 14, 16, 18, as seen in FIG. 1, biasing the respective rollers 22, 24, 26 circumferentially (anti-clockwise in FIG. 1) away from the wider portions of the recesses 14, 16, 18 and towards the narrower ends of the recesses 14, 16, 18.

The rollers 22, 24, 26 are captively held within their respective recesses 14, 16, 18 by being positioned between the walls of the recesses 14, 16, 18 and the outer wall 32 of the inner body 30. The sizes of the rollers 22, 24, 26 are such that the diameters of the rollers 22, 24, 26 are smaller than the widths of the widest portions of their respective recesses 14, 16, 18, but greater than the widths of the narrowest portions of the respective recesses 14, 16, 18.

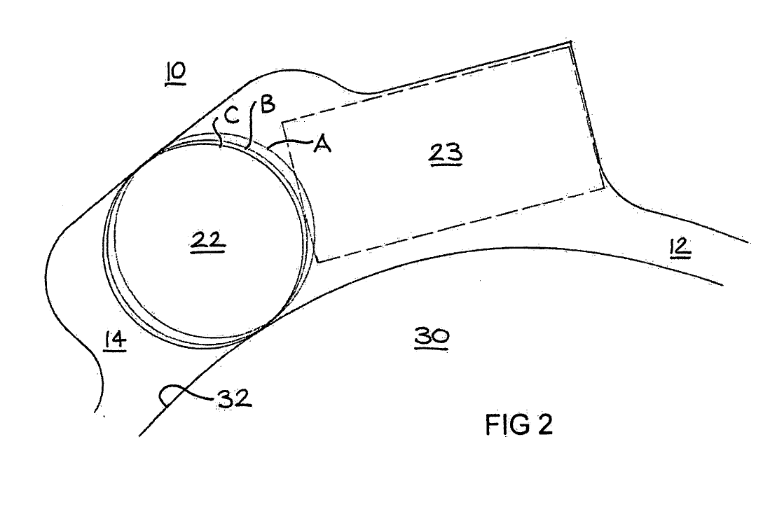

FIG. 2 illustrates the positioning and operation of the first roller 22 in the first cavity 14, in use. The first roller 22 is illustrated in three positions, designated by the letters A, B and C, corresponding to three different states of the torque transmission mechanism. The second and third rollers 24, 26 operate analogously.

When the inner body 30 is not rotating relative to the outer body 10, the springs 23, 25, 27 tend to force the rollers 22, 24, 26 towards the narrower portions of the recesses 14, 16, 18. Under these circumstances the rollers 22, 24, 26 are each held in a circumferentially intermediate position with respect to the recesses (corresponding to position B in FIG. 2) in which they are in gentle contact with the respective cam surfaces 14a, 16a, 18a and with the outer surface 32 of the inner body 30. This corresponds to a “contact” or neutral state of the torque transmission mechanism (and the tool).

Rotation of the inner body 30 in a clockwise direction (as seen in FIG. 1) relative to the outer body 10, tends to force the rollers 22, 24, 26 against the springs 23, 25, 27 and towards the wider portions of the recesses 14, 16, 18. Under these circumstances the rollers 22, 24, 26 are each held in a circumferentially more clockwise position (as shown in FIG. 1) with respect to the recesses (corresponding to position A in FIG. 2). In this state the outer and inner bodies 10, can move freely relative to each other in this specified direction. This corresponds to a “free running” state of the torque transmission mechanism (and the tool).

Rotation of the inner body 30 in an anti-clockwise direction (as seen in FIG. 1) relative to the outer body 10 tends to force the rollers 22, 24, 26 towards the narrower portions of the recesses 14, 16, 18, into a more anti-clockwise position. Under these circumstances the rollers 22, 24, 26 are each held in a circumferentially more anti-clockwise position (as shown in FIG. 1) with respect to the recesses. This corresponds to position C in FIG. 2. Because the diameter of each roller 22, 24, 26 is larger than the width of the narrower portion of the respective recess, each roller is forced firmly against both a cam surface 14a 16a, 18a and the outer surface 32 of the inner body 30, thus halting relative rotation of the inner and outer bodies 10, 30 in this specified direction. This corresponds to a “rotationally locked” or torque transmitting state of the torque transmission mechanism (and the tool).

Thus the mechanism 1 acts as a clutch mechanism to engage and disengage the inner and outer bodies 10, 30, allowing relative rotation in one direction only. The dimensions and tolerances of the components are arranged, in the preferred embodiment, so that there are only very small angles between the different positions of the rollers which correspond to the different states of the tool and torque transmission mechanism. In the preferred embodiment the angular difference in the position of a given roller, with respect to the outer body, between the neutral state B and the free running state A is about one degree, and the angular difference in the position of a given roller, with respect to the outer body, between the neutral state B and the locked state C is no more than about half a degree. This provides a mechanism which can rotationally lock the inner and outer bodies 10, 30 in less than one degree, in contrast to a ratchet type mechanism with 72 teeth which requires an angular movement of five degrees for the pawl to move from an engagement position with one ratchet tooth to the same position on the next ratchet tooth. The rapid engagement between the neutral state B and the locked state C is facilitated by the biasing action of the springs 23, 25, 27.

The provision of at least three angularly widely spaced rollers allows the inner body 30 to be maintained and supported generally centrally in the cavity 12.

It should be noted that the mechanism may be constructed so that the rollers do not all exhibit the same angular differences in their position corresponding to the different states of the mechanism this consideration will be described in more detail later.

A fourth recess 20 houses a spherical roller 21. The fourth recess 20 provides a cam surface 20a which allows relatively free motion of the spherical roller 21 when the inner body 30 rotates in the clockwise direction (as viewed in FIG. 1) relative to the outer body 10, but causes locking of the roller 21 between the cam surface 20a and the outer surface 32 of the inner body 30 if the inner body 30 begins to rotate in the anti-clockwise direction relative to the outer body 10. The cam surface 20a includes a stop portion 20b which engages the spherical roller 21 in the locked position. The stop portion 20b is generally arcuate in shape, with a radius of curvature approximately equal to the radius of the spherical roller 21, thus providing a relatively large area of contact between the stop portion 20b and the spherical roller 21. The cam portion is preferably a close fit with the spherical roller in three dimensions rather than just two. That is, stop portion 20b may have a concave part-spherical shape, which is centred on the centre of the spherical roller 21 when the spherical roller 21 and the stop portion 20b are in contact.

The provision of a fourth roller in the form of the spherical roller 21 allows the inner body 30 to be supported generally centrally in the cavity 12 more securely and accurately than it would be by the first to third rollers 22, 24, 26 alone, and also assists with the distribution of load. As illustrated in FIG. 1, the arcuate stop portion 20b extends approximately ninety degrees around a circumference of the spherical roller 21 but it will be appreciated that greater or lesser angular extent is possible owing to the structure of the recess, the stop portion can not extend more than (almost) 180 degrees around the spherical roller, otherwise it would permanently contain the roller. In practice, increasing angular extent much above the illustrated ninety degrees provides little benefit, since little force would be directed through the additional surface. An angular extent of much less than ninety degrees would reduce the load distributing surface and is therefore less preferred, but could be used if considered to provide adequate distribution of load. An angular extent of about 90 degrees is therefore preferred, although in other embodiments stop portions with angular extents about the roller from about 30 degrees (or even less) to about 150 degrees could be provided. The provision of the described configuration of stop surface 20b assists the spherical roller 21 to effectively protect the cylindrical rollers from excessive forces which might damage them or the surfaces of the inner and outer bodies 30, 10 which they bear on. Such damage could affect the operation of the mechanism and might increase the small angular displacement between the neutral position B and the locked position C. In alternative embodiments, there may be more than one roller which has a fitted stop portion. In the preferred embodiment, the rollers 21, 22, 24, 26 are not equally spaced and the spherical (or “stop”) roller 21 is positioned approximately 90 degrees away from the largest cylindrical roller (the third roller 26).

An important feature of this embodiment is that the diameter of the third roller 26 is considerably greater than the diameters of the first and second rollers 22, 24. The dimensions of the third recess 18 and the third spring 27 are also correspondingly greater than those of the first and second recesses 14, 16 and the first and second springs 23, 25.

The provision of a larger diameter roller as the third roller 26 gives greater contact areas between the third roller 26 and each of the inner and outer bodies 10, than would be given if the third roller 26 were of smaller diameter. Thus, the load bearing capacity of the tool is enhanced by use of a larger roller. Keeping the overall size of torque transmission mechanisms to a minimum is often of critical importance, and increasing the size of a roller will generally lead to an increase in overall size of the mechanism (all other things being equal). Thus, considering FIG. 1, if the diameters of the first and second rollers 22, 24 were to be increased, the radial sizes of the first and second recesses 14, 16 would have to be increased correspondingly. Then to maintain the same minimum radial thickness of the outer body 10, the overall dimensions of the outer body 10 (and thus the overall dimensions of the tool head) would have to be increased, which would be undesirable. In the described embodiment, however, the larger diameter third roller 26, and the correspondingly larger third recess 18 are positioned at or close to the centre line of the tool, that is, they are substantially between the inner body 30 and a handle 92 of the tool. Thus, the larger third recess 18 is formed in a part of the tool where it can be accommodated without decreasing the minimum wall thickness and without increasing the overall size, or working diameter of the tool.

In the preferred embodiment the first and second rollers 22, 24 and the spherical roller 21 each have a diameter of 4 mm, the third roller 26 has a diameter of 6 mm, the inner body 30 has a diameter of 22 mm, and the outer body 10 has an outside working diameter (ie a width in the direction perpendicular to the axis of the handle of the tool) of 34 mm. In an alternative embodiment, with improved load bearing capacity, but also increased size, the first and second rollers and the spherical roller each have a diameter of 6 mm, the third roller has a diameter of 8 mm, the inner body has a diameter of 23 mm, and the outer body has an outside diameter (ie a maximum width in the direction perpendicular to the axis of the handle of the tool) of 40 mm. The 40 mm head width allows for a bore of a square half inch (12.7 mm) bore to accommodate a standard half inch square drive block.

In a preferred embodiment the cam surfaces are arranged so that the locking of the first to third rollers 22, 24, 26 and the spherical roller 21 occur progressively, that is, in very close succession, rather than simultaneously.

It is preferred that the smaller first and second rollers 22, 24 become substantially locked first, that the larger third roller 26, becomes substantially locked momentarily thereafter, and that the spherical roller 21 locks last. The spherical roller 21, having a large contact area with the stop portion 20b of corresponding cam surface 20a and engaging last, acts as an effective end stop, preventing undue load being applied between the first to third rollers 22, 24, 26 and the respective cam surfaces 14a, 16a, 18a. It will be appreciated that the sequential locking of the rollers occurs in extremely quick succession: the last roller to lock will do so only a fraction of a degree behind the first.

In the described preferred embodiment, the larger third roller 26 engages about a sixth of a degree after the first and second rollers 22, 24 and the spherical roller 21 engages less than half a degree later. The profiles of the cam surfaces 14a, 16a, 18a, 20a, taking into account the diameters of the rollers 22, 24, 26, 21 and any other relevant factors, such as the magnitude of the force applied by the springs 23, 25, 27 dictate the exact angular displacement required for each roller to engage from a neutral to a locked position, and the desired sequence can be provided. Because the engagement of the rollers 22, 24, 26, 21 is in extremely quick succession, and the cam surfaces are inclined only a few degrees, so that the widths of the recesses vary only slightly, any compression of the rollers 22, 24 which engage earlier (between the cam surfaces 14a, 16a and the inner body 30) will be of the order of micrometers and should be readily absorbed by the elasticity of the rollers without damage to the rollers or other elements of the mechanism 1.

An advantage of this sequential locking of the rollers is that positive and firm locking of the rollers can be provided without damage, thus maintaining the small tolerances of the mechanism and the very rapid locking action thereof.

The shapes and dimensions of the various elements of the preferred embodiment were calculated with the assistance of a CAD computer program, and the operation of the mechanism checked by computer simulation before construction of the mechanism. In actual construction of a prototype, it may be of assistance to provide an inner body which is slightly oversized and then gradually reduce the diameter of the inner body by machining until the desired fit and interaction between the parts is achieved.

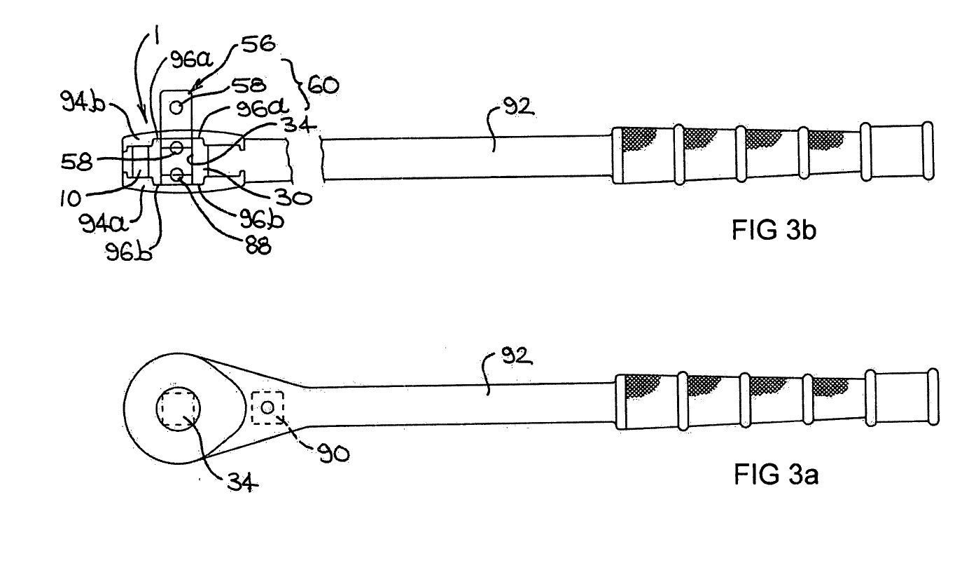

The inner body 30 has a square cylindrical bore 34 therethrough. The square cylindrical bore 34 is adapted to receive a slideable square drive block 56, as shown in FIG. 3b. The slideable square drive block 56 includes a releasable locking mechanism in the form of a number of ball detents 58 on its axially extending faces. The ball detents 58 are retained in the drive block 56, but are resiliently biased to stand slightly proud of its surface. The ball detents 58 releasably lock into place with respective recesses 36 (as shown in FIG. 1) within the bore 34 so that the drive block 56 is retained in the bore 34 with part of the length of the drive block 56 exposed. The exposed part 60 of the drive block 56 is adapted to releasably lockingly couple to a socket or other tool piece (not shown) to be rotated, via the ball detents thereon. (The action of a square drive block coupling to a socket or other tool piece by use of ball detents is not new per se, and will be understood by the skilled person.)

The bore 34 extends all the way through the inner body 30, and the drive block 56 may be fitted to the inner body 30 so as to extend from one axial side of the inner body 30, or from the opposite side thereof, depending on whether it is desired to rotate the socket or tool piece in a clockwise or counter-clockwise direction. It will be appreciated that a wide range of tool pieces can be driven via the drive block 56 (and possibly also via an appropriate adaptor) including screwdriver bits, Allen key bits and the like. It will also be appreciated that although a square bore 34 is provided in the described embodiments, other cross-sectional shapes of bore could be provided, or attachment to tool pieces to be driven could be via any other appropriate connection. Although it is preferred that the drive block attaches to a bore 34 which passes through the inner body 30 embodiments are envisaged in which the bore 34 is replaced by a suitably shaped cavity on either side of the inner body, which would provide a similar means of attaching a drive block.

As illustrated in FIGS. 1, 3a and 3b, in addition to the primary square bore 34 in the inner body 30, a preferred embodiment of a tool includes a secondary square bore 90 for receiving a complementary drive block (not shown) of a standard handle, such as is provided on commercially available torque wrenches and the like. Allowing connection of a torque wrench (that is, a wrench which allows a given torque, or less, to be applied to a driven member but which indicates when the given torque is reached or exceeded—typically by tripping of a handle portion with an adjustable setting) in this way allows a torque wrench to be connected to the tool so as to make use of the benefits of the tool. This allows the torque wrench to be used in a restricted space, where little angular motion of the handle is possible, possibly allowing such a torque wrench to be used where it could not otherwise be used effectively. In an alternative embodiment, the type of torque sensitive handle portion typically used on a torque wrench forms the handle portion of a tool in accordance with one or more aspects of the present invention. That is, such an embodiment could be similar to the tool of FIG. 1 but with a torque indicating handle.

As described above with reference to the bore 34, the secondary bore 90 could be replaced by suitably shaped cavities. If the tool of FIGS. 3a and 3b is used with a normal torque wrench, it might be necessary to tolerate some inaccuracy in the torque applied, or to perform some re-calibration of the torque wrench in order to allow for the effective increase in length created by the distance between the primary and secondary bores 34, 90. If the distance between the primary and secondary bores 34, 90 is small compared to the length of the torque wrench handle any inaccuracy created will be small.

Use of the secondary bore 90 is not limited to use with torque wrenches. It may be beneficial to attach a square drive tool to the tool of FIGS. 3a and 3b for altering the angle of the handle with respect to the tool or effectively lengthening the handle.

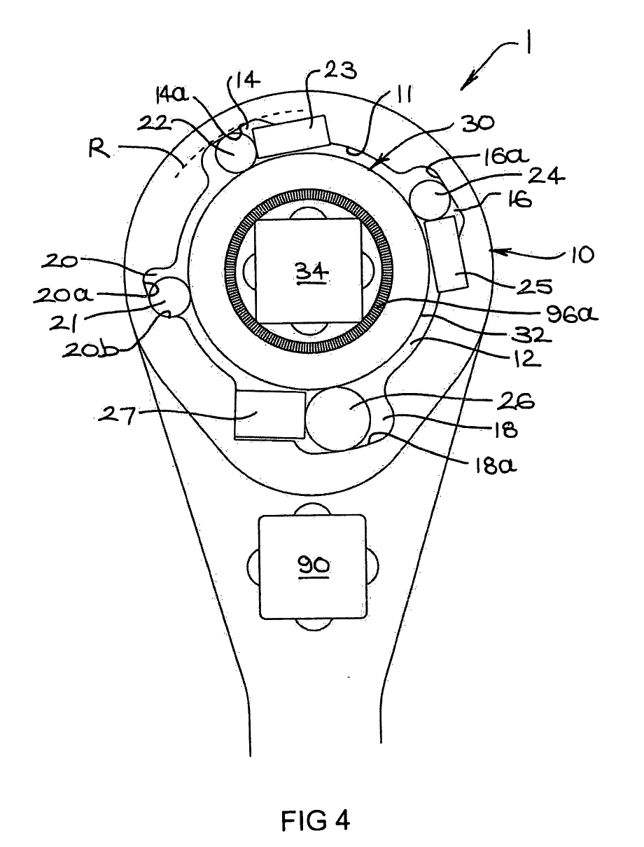

Referring to FIG. 3b, the inner and outer bodies 30, 10 are retained together by cover members 94a, 94b which are attached in any suitable fashion. Options for attachment of the covers 94a, 94b will be appreciated by the skilled addressee. A preferred embodiment includes first and second circular seals 96a, 96b which extend around and slightly spaced from the bore 34, in grooves set into respective axial end faces of the inner member 30 and respective grooves in the cover members 94a, 94b. The seals 96a, 96b seal the inner body 30 to the cover members 94a, 94b, isolating the rollers 22,24,26, 21 and other internal components from external contaminants such as dust and even water. The arrangement of one such seal 96a is shown in FIG. 4 (which otherwise corresponds to FIG. 1). The seals 94a, 94b are preferably in the form of ‘O’ rings and formed from a material such as a self lubricating plastic or from neoprene, which is durable enough to withstand prolonged use between the relatively moving parts. The embodiment of FIG. 4 illustrates how well suited the structure of some preferred embodiments may be, for provision of seals therein. In some cases, it would be possible to incorporate similar sealing methods into other types of torque transmission mechanisms and tools, including conventional ratchet and pawl type arrangements such as those in ratchet socket wrenches. From the teaching of this document, the skilled person will gain an appreciation of how this could be achieved.

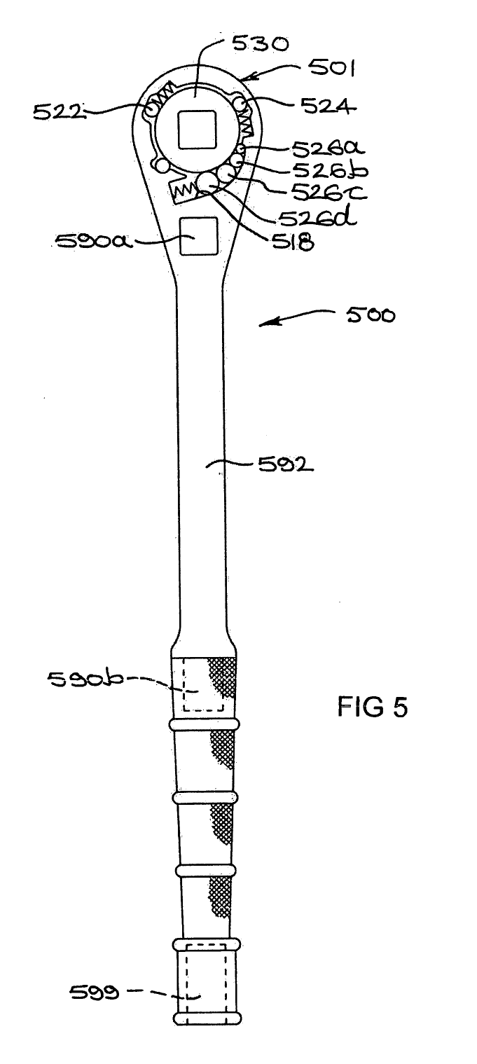

FIG. 5 shows an alternative embodiment of a tool, generally designated 500, including an alternative embodiment of a torque transmitting mechanism 501. This embodiment differs from the embodiment of FIGS. 1 to 3b mainly in that a third recess 518 located generally between an inner body 530 and an elongate handle portion 592 includes first to fourth rollers 526a, 526b, 526c, 526d at least one 526d of which is of greater diameter than other rollers 522, 524, 521 which are spaced around the circumference of the inner body 530. The embodiment of FIG. 5 includes first and second secondary bores 590a, 590b of which the first bore 590a is close to the torque transmission mechanism 501 and the second 590b is spaced a considerable distance from the torque transmission mechanism 501 along the handle portion 592. The end of the handle portion 592 which is distal from the torque transmission mechanism 501 includes an axially extending cavity 599 for receipt of a drive element of the same dimensions as the drive elements which the bores 590a, 590b are adapted to receive. This enables suitable extension handles (see e.g. FIGS. 10a and 10b) to be located coaxially with the handle portion 592.

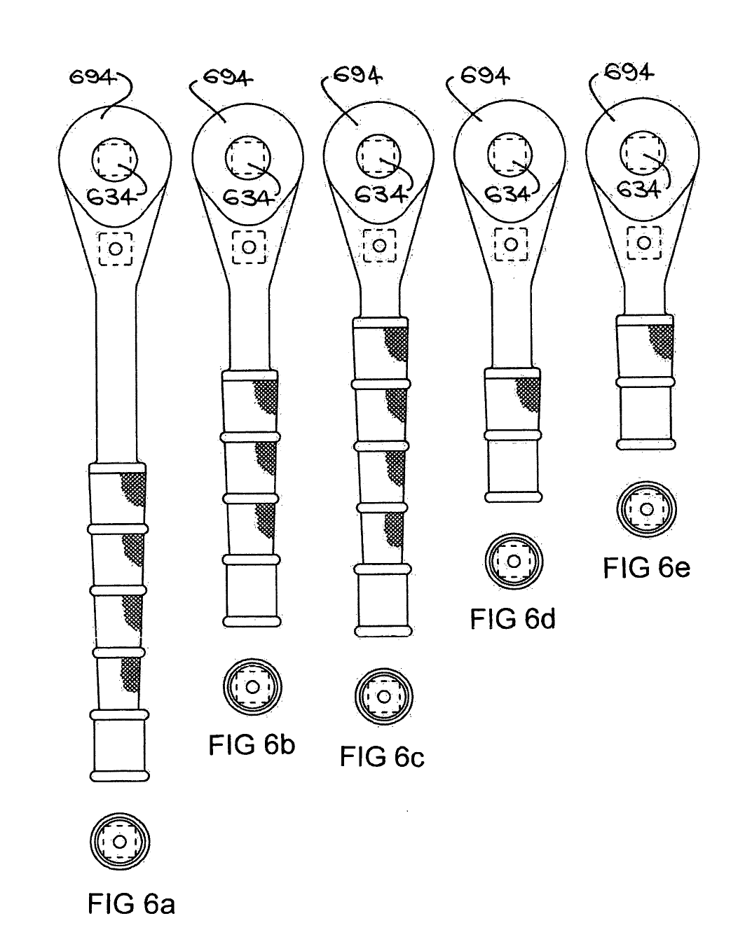

FIGS. 6a to 6e show further embodiments of tools, having handle portions of different lengths, and each including an axially extending cavity, as shown in the respective end views, for connection to an extension handle. It will also be noted that the covers 694 of the various embodiments extend close to the bores 634 of the inner bodies (not shown) providing an attractive appearance and adequate overlap of the cover 694 and an inner body (not shown) to facilitate provision of seals (not shown) between these parts.

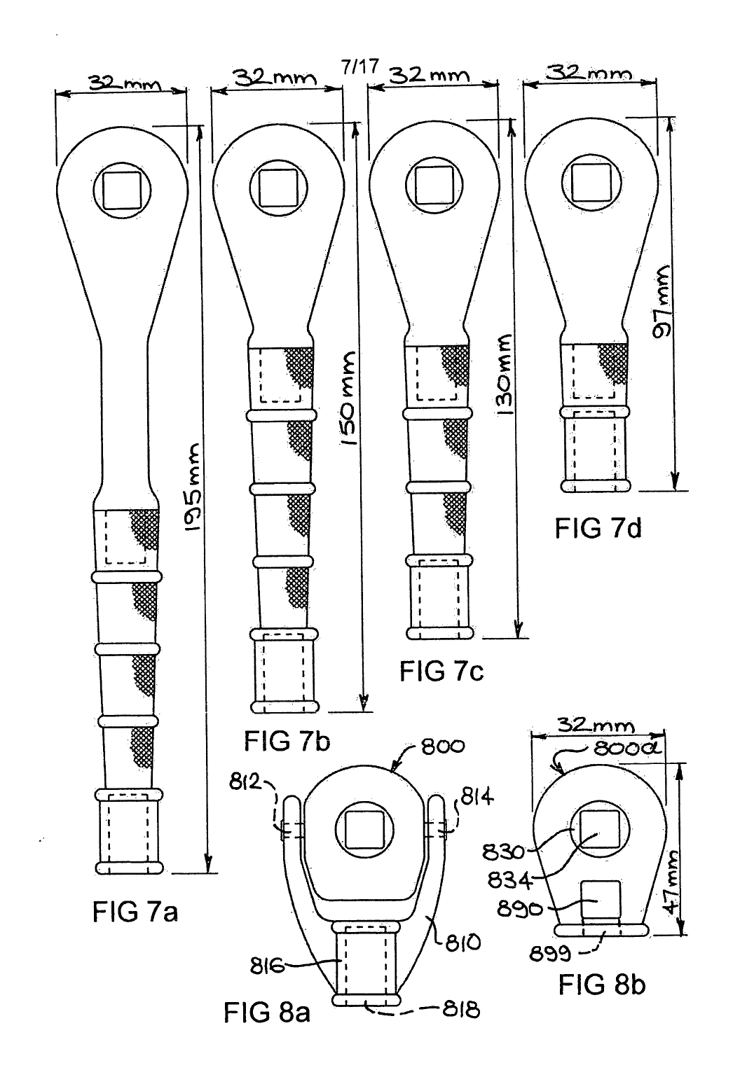

FIGS. 7a to 7d show further embodiments with different appearances to those of FIGS. 6a to 6e. FIGS. 7a to 7d include dimensions, by way of example only, to illustrate the sizes of envisaged embodiments.

FIG. 8a is a plan view of an embodiment of a tool head generally designated 800, pivotally attached to a yoke 810 by first and second pivot pins 812, 814. The yoke 810 includes a central body portion 816, in which is provided a cavity 818 which is dimensioned suitably for receipt of a drive element (not shown) of another tool (not shown).

FIG. 8b is a plan view of an embodiment of a tool head, generally designated 800a, including an inner body 830 having a square bore 834 therethrough. The tool head 800a also includes a secondary bore 890 and an axial attachment portion 899, the functions of which will be appreciated from the above description relating to other embodiments.

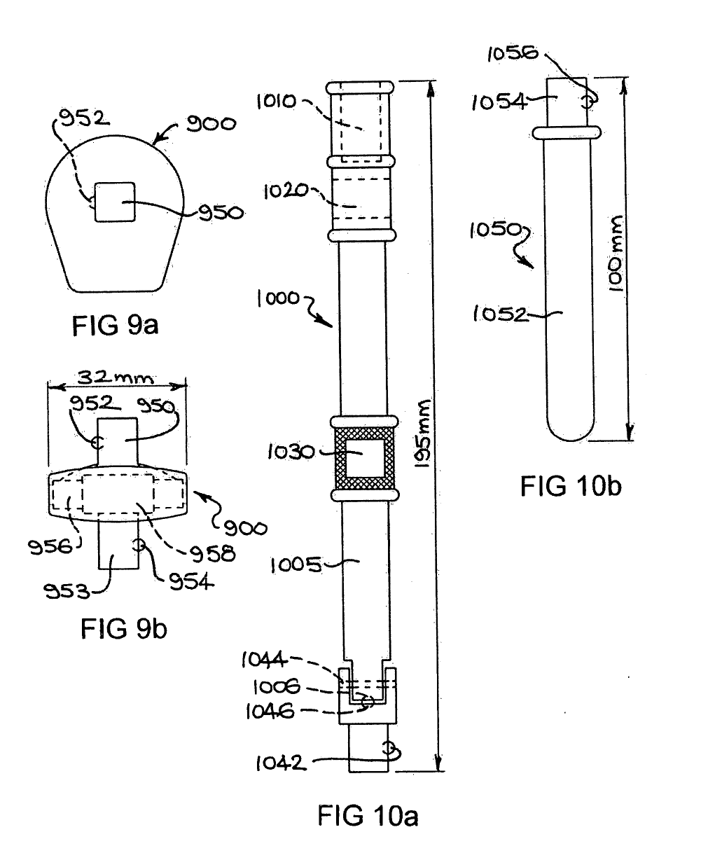

FIGS. 9a and 9b show an embodiment of a tool, generally designated 900. The tool 900 has a first drive element 950, which is ⅜ inch (9.5 mm) square in cross-section and which includes a first ball detent 952, extending from one side thereof and a second similar drive element 953, having a second ball detent 954, extending from the other side thereof.

The first drive element 950 is attached to an outer body 956 of a torque transmission mechanism and the second drive element 953 is attached to an inner body 958 of the torque transmission device. The outer body 956 and inner body 958 may interact, and be structured, similarly to the corresponding parts of other embodiments described herein. It will be appreciated that this embodiment therefore provides an “in-line drive” whereby torque applied in a first direction to the first element 950 will be transmitted to the second element 953, but a torque applied in the opposite direction will not be transmitted from the first drive element 950 to the second drive element 953.

In use the rotational direction in which a torque may be transmitted from a driving one of the drive elements 950, 953 to a driven one of the drive elements 950, 953 may be determined by selecting which of the drive elements 950, 953 is used as the driving element and which is the driven element. That is, in use, (assuming that the tool is being used with the axis of the drive elements in a vertical orientation) the torque transmitting direction may be selected by choosing which way up to use the tool 900.

It will be appreciated that the tool 900 provides a one-way torque transmitting device which may be placed for example between a driving handle and a tool piece, such as a socket, or between other elements required to transmit torque in one rotational direction between suitable tools. The in-line tool 900 thus provides a compact mechanism for conveniently converting a drive train without a one-way clutch into a drive train including a one-way clutch.

FIG. 10a shows a tool handle, generally designated 1000 including a main body 1005 in the form of a generally cylindrical rod. The tool handle 1000 includes at a first end thereof an axial cavity 1010 and a radial through bore 1020, each being suitably dimensioned to receive a drive element. In this embodiment, the axial cavity 1010 and the through bore are each square in cross-section ⅜ inch (9.5 mm) on each side. A further similar radial bore 1030 is provided at an axially central part of the tool handle. At a second end of the tool handle 1000, there is provided a male drive element 1040 (which is ⅜ inch −9.5 mm on each side). The male drive element 1040 includes a first ball detent 1042 on a face thereof for snap connection into a suitable cavity of a tool piece (not shown). The male drive element 1040 is pivotally attached to the main body 1005 of the tool handle 1000 by a pivot pin 1044. The male drive element 1040 may be resiliently retained in an orientation in which it is coaxial with the main body 1005 by interaction of a second ball detent 1046, located on the male drive element 1040, with a complementary indentation 1006 on the main body 1005.

FIG. 10b shows an alternative tool handle 1050 consisting of a generally straight elongate handle portion 1052 with a square cross-sectional male drive element 1054 at one end thereof. The drive element 1054 includes a ball detent 1056 on a face thereof.

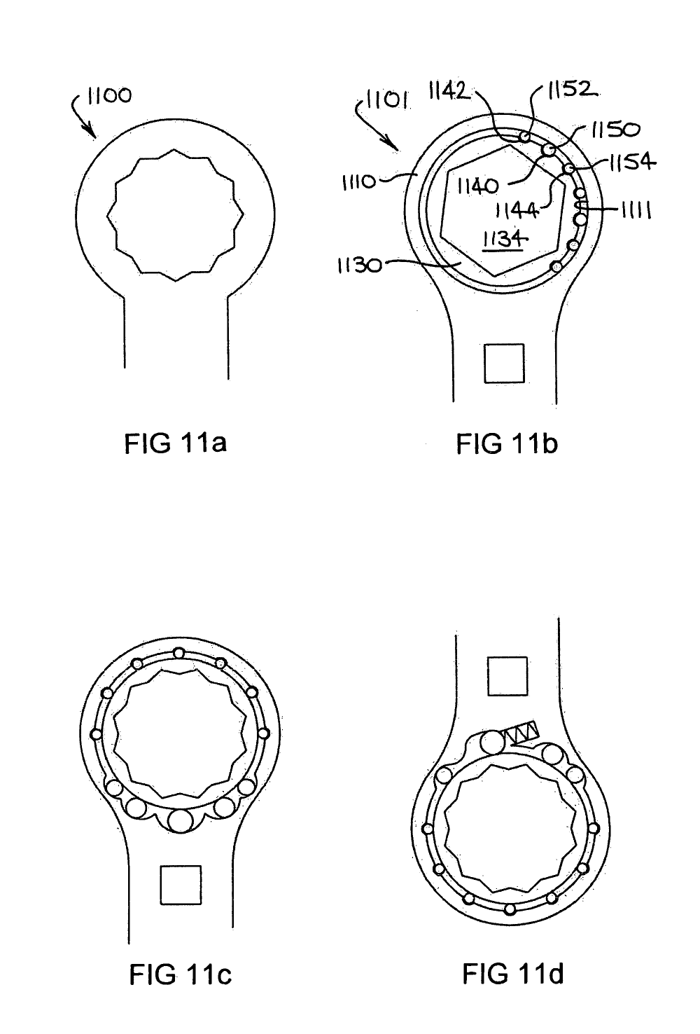

FIG. 11a is a plan view of a conventional ring spanner 1100 of the type stamped from a sheet of metal.

FIG. 11b is a partial cross-sectional view of an embodiment of a tool 1101 in the form of a ring spanner which includes an embodiment of a torque transmission mechanism. For clarity, only some of the recesses and rollers are shown. The tool includes an outer body 1110, and a generally circular inner body 1130 which includes a hexagonal cross-section bore 1134 therethrough. Since the bore 1134 is hexagonal and the inner body 1130 is generally circular, it will be appreciated that the wall thickness of the inner body 1130 is (excluding the effect of any recesses) greater in the vicinity of the centres of the sides of the hexagonal bore 1134 than it is in the vicinity of the corners of the hexagonal bore 1134. Thus, if a given minimum wall thickness of the inner body 1130 is required, in order to provide the required-strength, there is scope to provide larger recesses in the vicinity of the centres of the sides of the hexagonal bore 1130 than in the vicinity of the corners.

Thus, for each side of the hexagonal bore 1130 the inner body includes a larger recess 1140 in the vicinity of the centre of the side, and first and second smaller recesses 1142, 1144 on respective first and second sides of the larger recess 1140. The larger recess 1140 includes a larger roller 1150 and the first and second smaller recesses 1142, 1144 include first and second smaller rollers 1152, 1154. It will be appreciated that the recesses 1140, 1142, 1144 are provided with cam surfaces which dictate that only one direction of relative rotation of the inner body 1130 and outer body 1110 is facilitated. The rollers 1150, 1152, 1154 bear against respective cam surfaces of the recesses 1140, 1142, 1144 and against a circular inner race formed by an inner wall 1111 of the outer body 1110. The rollers could be spherical or cylindrical. Needle rollers could be used.

Thus, the embodiment of FIG. 11b provides an embodiment in which the recesses are provided in the inner body 1130.

FIGS. 11c and 11d show schematically alternative embodiments of ring spanners including embodiments of torque transmission mechanisms in accordance with aspects of the present invention in which rollers are provided in recesses in the outer body and the rollers are spaced about the periphery of the inner body such that larger rollers, in larger recesses, are provided generally between the inner body and a handle portion of the respective spanners. The smaller rollers are preferably needle rollers and the larger rollers may be all cylindrical rollers (not shown) all spherical rollers, as shown in FIG. 11c or a combination of spherical and cylindrical rollers, as shown in FIG. 11d.

Each of the embodiments of FIGS. 11b, 11c and 11d include a connection part, in the form of a square bore, in a handle portion thereof for coupling to a drive element of another tool. These embodiments of ring spanners need not be much larger in size than a conventional ring spanner, but have the additional advantage of a one-way clutch mechanism. In the embodiments of FIGS. 11c and 11d as illustrated, at least one larger roller has a diameter slightly greater than double the diameter of the smaller rollers. Of course, the relative sizes of the diameters may be different in different embodiments.

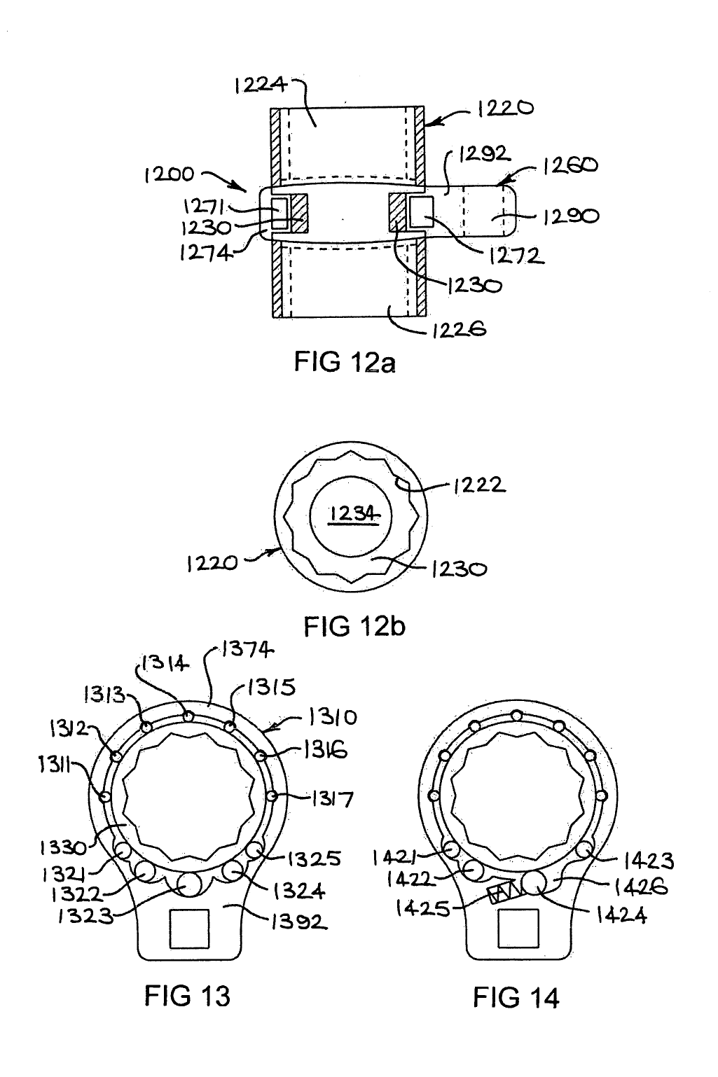

FIG. 12a shows an embodiment of a socket-like tool generally designated 1200, which has a generally cylindrical socket portion 1220 (shown in end elevation in FIG. 12b) which includes an inner body 1230 of a torque transmission mechanism and a tool connection portion 1260 which includes an outer body (not shown) of a torque transmission mechanism. The inner body 1230 is generally axially centrally located in the socket portion 1220 and extends along approximately the central third of the socket portion 1220. The tool connecting portion 1260 includes a wall 1274 which extends around the socket portion 1220 at a generally axially central portion thereof, where a waist is formed in the socket portion 1220 so that the inner body 1230 has a smaller diameter than the socket portion 1220 as a whole. This facilitates provision of a compact tool because the wall 1274 can be partly located in the waist, so that an outer periphery of the wall 1274 does not extend far beyond the outside of the socket portion 1220. An inner surface 1222 of the socket portion 1220 is formed so as to receive a fastener, such as a nut, bolt-head or the like, in the same manner as some known sockets. The inner body 1230 extends closer to the axis of the socket portion 1220 than does the inner surface 1222 to form an internal shoulder which, in use, can engage the end surface of a fastener such as a nut, bolt-head or the like. Thus, first and second fastener receiving cavities 1224, 1226 are formed by respective, first and second ends of the socket portion 1220. The cavities 1224, 1226 are connected be a central bore 1234 which extends through the inner body 1230. The socket portion 1220 thus has an elongate cavity extending axially all the way therethrough, allowing operation of, for example nuts on long threaded shaft, as the threaded shaft may extend through the socket portion 1220.

The tool connection portion 1260 includes a connection portion, for connection to another tool or tool handle, in the form of a square cross-section bore 1290. The part of the connection portion 1260 which includes the bore 1290 has a thick wall portion 1292 which extends further from the axis of the socket portion of the tool 1200 than the wall 1274 which extends around the inner body 1230. The tool connection portion 1260 (which includes the outer body) includes a number of recesses (not shown) each of which includes a respective roller 1271, 1272 therein.

At least one roller 1272 which is located in a recess in the thick wall portion 1292 has a greater diameter than at least one roller 1271 which is located in a recess in the thinner wall 1274. It will be appreciated from the foregoing description that the larger roller 1272 can be included without increasing the working diameter of the tool and without reducing the wall thickness beyond a tolerable limit, because of its location in a thicker portion of the wall. In this context the “thicker” wall portion is thicker when the effect or thickness of the cavity is excluded, that is, it would be “thicker” if the cavity were not present. Once the effect of the cavity on the wall is taken into account the remaining thickness of the wall (that is, the actual thickness of the least thick part of the wall in the vicinity of the cavity) might be no greater than the thickness of the thinner wall 1274.

The rollers 1271, 1272 interact with cam surfaces of the recesses and with the inner body 1230 by locking between them to prevent relative rotation of the inner body 1230 and the outer body in a predetermined direction, to provide a one way torque transmission mechanism. The socket portion 1220 is generally symmetrical about a plane which extends radially through the waist thereof, and the direction in which a fastener may be driven is determined by which axial end of the socket portion 1220 is used.

FIGS. 13 and 14 show schematically arrangements of rollers and recesses which could be included in the embodiment of FIGS. 12a and 12b. The embodiment of FIG. 13 includes first to seventh small-diameter generally cylindrical needle rollers 1311 to 1317 spaced circumferentially around an arcuate thinner wall portion 1374 of an outer body 1310 in respective recesses, and first to fifth larger diameter spherical rollers 1321 to 1325 located in recesses in a thicker wall portion 1392 which, in use, is generally between an inner body 1330 and a handle (not shown). It will be appreciated that although not shown in detail each of the rollers 1311 to 1317 and 1321 to 1325 may interact with the recesses and inner body 1330 to provide a one-way torque transmission mechanism.

FIG. 14 illustrates schematically an embodiment with an alternative configuration of rollers and recesses to that illustrated in FIG. 13. The embodiment of FIG. 14 differs from the embodiment of FIG. 13 in that it includes only three larger spherical rollers 1421, 1422, 1423 and includes a larger cylindrical roller 1424 biased by a spring 1425 towards a narrower circumferential end of a recess 1426. The operation of this embodiment can be understood from a consideration of embodiments described above. Alternative embodiments which are similar but with spring biased cylindrical rollers substituted for the spherical rollers, are envisaged. It is preferred to include at least one spherical roller to act as a stop, as described above. It will be appreciated that, like the embodiment of FIGS. 9a and 9b, the embodiments of FIGS. 11b to 14 allow selection of the direction in which a tool piece or fastener can be driven, by selection of the orientation of the tool in question.

It is believed that at least a preferred embodiment of a tool including the torque transmission mechanism described has advantages over tools including ratchet and pawl mechanisms to transmit torque. Perceived advantages include the following.

That rotational locking of the inner and outer bodies in not limited by the provision of a given number of teeth, and may occur in less than one degree, or in the most preferred embodiments in about 0.5 degrees, of relative rotation between the bodies.

That the arrangement of preferred embodiments is harder wearing than a typical corresponding ratchet mechanism for a one way tool head, since all the load bearing elements have considerable thickness (compared to a ratchet pawl) and may be manufactured of suitable durable and/or surface hardened materials. This prolongs tool life and reduces the risk of injury through tool failure and the need for regular maintenance of the tool head.

The tool head has few moving parts, also increasing tool life and decreasing maintenance requirements.

The provision of one or more larger rollers in the vicinity of the handle and smaller rollers spaced about the rest of the circumference, provides the advantage of including the one or more larger rollers without the consequent increase in size which the one or more larger rollers might necessitate if placed elsewhere on the circumference.

Use of one or more rollers, most preferably spherical rollers, which interact with one or more arcuate stop portions of respective cam surfaces helps distribute load, thereby protecting rollers and cam surfaces from damage.

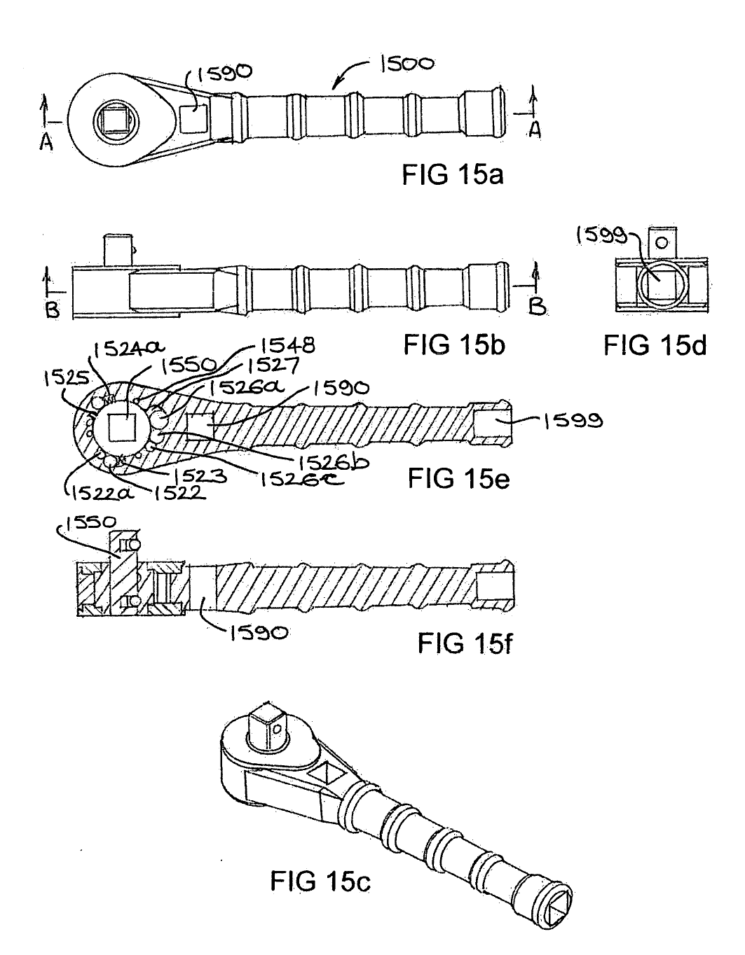

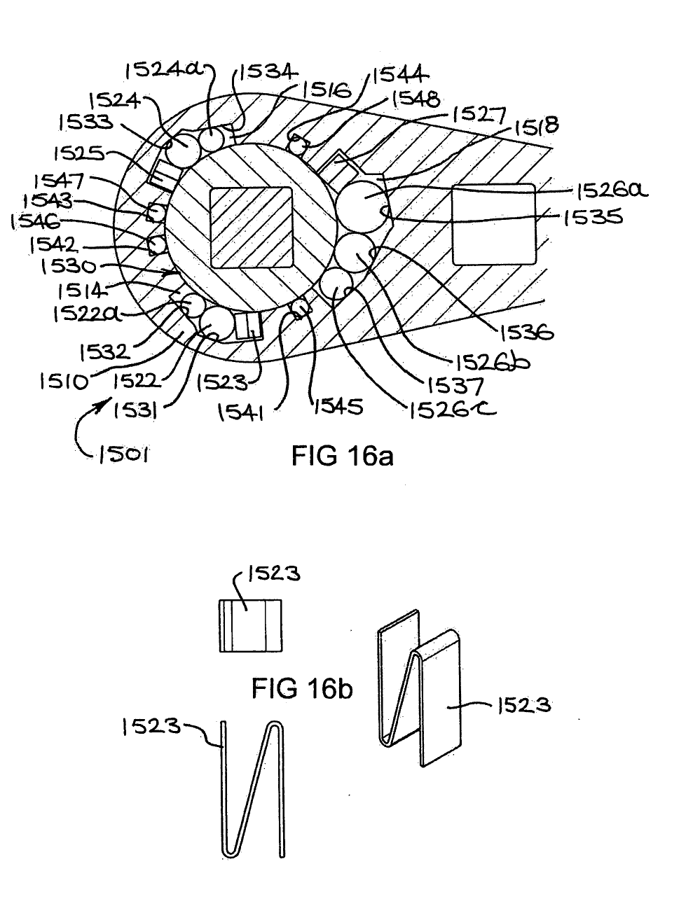

FIGS. 15a to 16b illustrate an alternative embodiment of a tool generally designated 1500, including an alternative embodiment of a torque transmission mechanism 1501. This embodiment has many similarities to embodiments described earlier, which will be evident from inspection of the drawings and which will not be described in detail. However, it is worth noting that the tool 1500, like some of the earlier embodiments, includes a secondary bore 1590 and an axially extending cavity 1599 to allow receipt of a drive element of another tool. The tool also has a drive element 1550 which is square in cross-section. The drive element 1550 includes first and second ball detents 1552, 1553 in order to allow the drive element to be securely fixed when extending from either side of the tool 1500, in order to allow one-way transmission of force in either desired direction.

The torque transmission mechanism 1501 is best illustrated in FIG. 16a, and includes a generally cylindrical inner body 1530 and a generally annular outer body 1510. The outer body 1510 includes first, second and third interaction member recesses 1514, 1516, 1518. The first and second interaction member recesses 1514, 1516 include respective first and second leaf springs 1523, 1525 which, in this embodiment, are generally N-shaped in cross section (as best shown in FIG. 16b). Each of the first and second interaction member recesses 1514, 1516 also includes a respective larger interaction member 1522, 1524 and a respective smaller interaction member 1522A. 1524A. The third recess 1518 includes a larger interaction member 1526A, an intermediate sized interaction member 1526B and a smaller interaction member 1526C. The third interaction member recess 1518 also includes a third spring 1527, which is slightly larger in size than the first and second springs 1523, 1525. It will be appreciated from an understanding of the earlier described embodiments that the interaction members or, in this embodiment rollers, 1522, 1522A, 1524, 1524A, 1526A, 1526B, 1526C are biased in a clockwise direction by the springs 1523, 1525, 1527 (as shown in FIG. 16a) in order to allow the inner body 1530 to rotate in a first direction with respect to the outer body, but to effectively prevent rotation of the inner body 1530 with respect to the outer body 1510 in the opposite direction.

Each respective interaction member is able to interact with a respective cam portion formed on the inside of the associated recess. However, it will be noted that in this embodiment cam portions 1531 to 1537 are substantially straight where they interact with the rollers or interaction members. The provision of substantially straight cam portions 1531 to 1537 in this embodiment allows each of the interaction members to interact with a substantially straight flat surface of the cam.

In the preferred embodiment, the flat surfaces of the straight cam portions are inclined at approximately six degrees from a circumferential direction with respect to the axis of the torque transmission mechanism. In the preferred embodiment, it has been found that this arrangement can allow the inner and outer bodies to be locked against relative rotation in the second direction in approximately five seconds of one degree of rotation of the inner body 1530. It will be noted that the recesses include stepped portions between the straight cam portions 1531 to 1537, to allow for the differences in size between the adjacent interaction members, and differences in angle of adjacent cam portions.

In addition to the three interaction member recesses 1514, 1516, 1518 the outer body 1510 includes first to fourth location member recesses 1541 to 1544, which retain respective first to fourth location members 1545 to 1548 therein. The location members 1545 to 1548 support the inner body 1530 in position relative to the outer body 1510 and effectively prevent radial movement thereof. In the preferred embodiment, the location members 1545 to 1548 are rollers, and could be either ball bearings or cylindrical rollers. The location member recesses are provided to retain the location members to within a fine tolerance, but to provide minimal friction to the location members.

It will thus be appreciated that in this embodiment, the location of the inner body 1530 relative to the outer body 1510 and the provision of a low friction connection between the inner body and the outer body in order to allow substantially unimpeded movement of the inner body relative to the outer body in the first direction is provided by the location members 1545 to 1548. However, the mechanism preventing the inner body 1530 from rotating relative to the outer body 1510 in the second direction is provided by the interaction members 1522, 1522A, 1524, 1524A, 1526A, 1526B, 1526C and their interaction with the cam portions 1531 to 1537. Using different elements to perform these two functions allows a lower friction rotation of the inner body 1530 relative to the outer body 1510 in the first direction.

Alternative configurations of location members are of course possible. For example, location members in the form of rollers could be provided in one or more circumferential grooves on the inner surface of the outer body, providing that they are positioned so that there is no interference between location members and interaction member—s for example they could be axially spaced apart from the interaction members. Thus, the location members could be in a configuration similar to a ring bearing such as that used in a bicycle wheel, to provide a low friction action. Although not preferred, it may be possible to use location members such as sleeves of low friction material, rather than rollers.

The interaction members are shown in this embodiment as being rollers. However, it is possible that other shapes of interaction member could be used. Furthermore, the interaction member recesses could include different numbers of interaction members interacting with suitably angled and positioned cams.

In the preferred embodiment, the interaction members include two 3 mm diameter rollers (interaction members 1522A, 1524A), three 4 mm diameter rollers (interaction members 1522, 1524, 1526C), one 5 mm diameter roller (interaction member 1526B) and one 6 mm diameter roller (interaction member 1526A). Each roller is generally cylindrical and about 10 mm long, and in use each locks by interacting with both the respective straight cam face and the centre runner, and interaction with one or more adjacent interaction members may also contribute to the locking of the members.

In the preferred embodiment, the interaction members may lock sequentially, with the smaller rollers locking first and progressively larger rollers locking extremely soon thereafter. The N-shaped leaf springs 1523, 1525, 1527 provide a suitable bias force to allow the inner body 1530 to free wheel effortlessly within the outer body 1510 in the first direction and to allow the interaction members to lock in about five seconds of one degree of movement in the second direction.

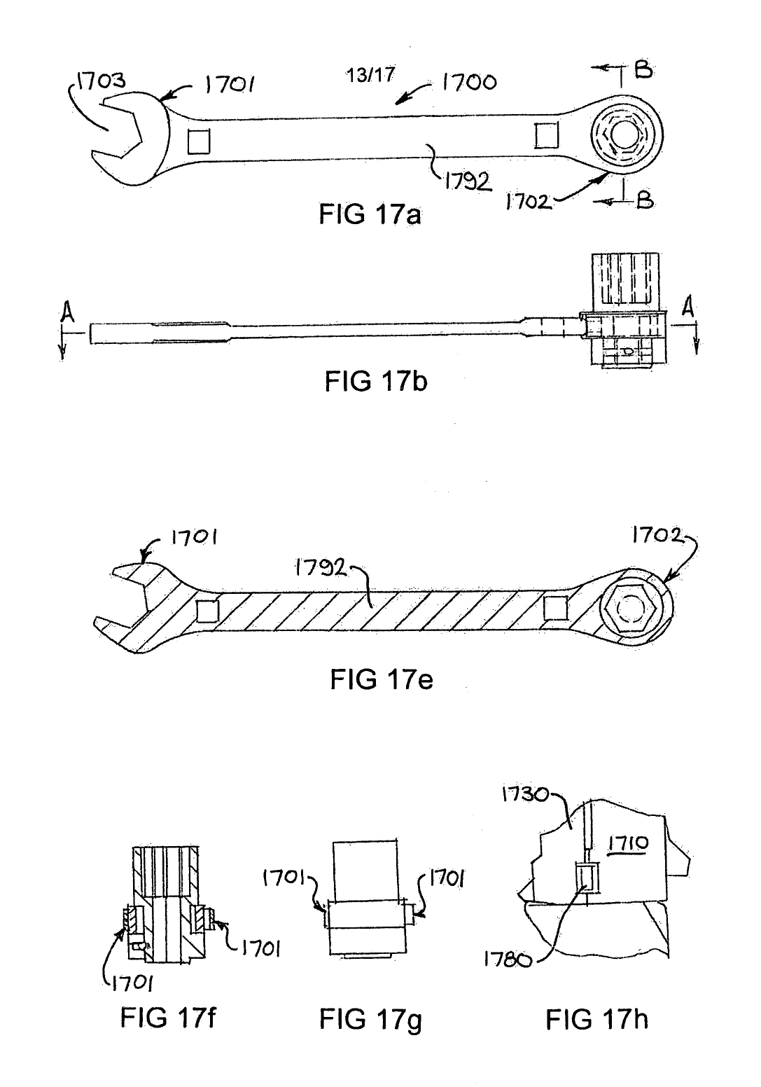

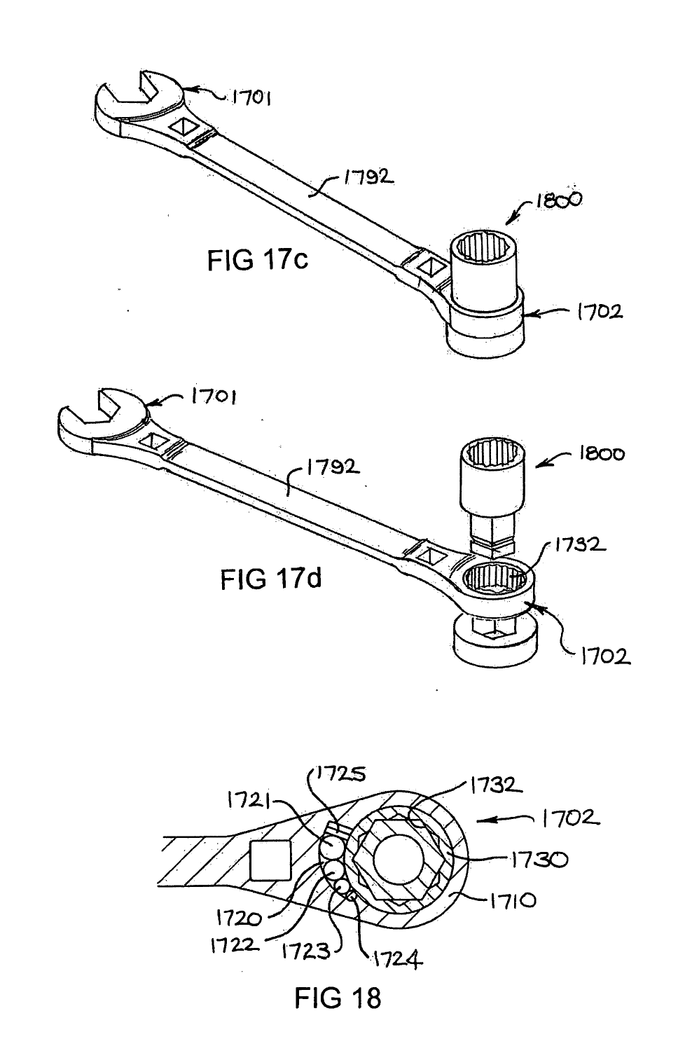

FIGS. 17a to 20 illustrate a further embodiment of a tool including a torque transmission mechanism. As seen in FIGS. 17a, 17c, 17d and 17e the tool, generally designated 1700, is a combination spanner having a spanner head 1701 at a first end thereof and a one-way torque transmission mechanism 1702 at a second end thereof, with a handle portion 1792 extending therebetween.

The spanner head 1701 includes an open connection portion 1703 for connection to a hexagonal nut or bolt-head (not shown). Unlike other spanner heads, the open connection portion includes four straight sides each adapted to fit closely to a side of a hexagonal fastener such as a nut or bolt-head, allowing distribution of the load applied thereto. Of course, different shapes of connection portion could be provided to fit to fasteners having other polygonal shapes, but it is preferred that the connection portion includes a straight side for more than half of the sides of a polygonal fastener which the spanner head is adapted to fit.

The motion transmission mechanism 1702 is best illustrated by FIG. 18. The notion transmission mechanism 1702 includes an inner body 1730 and an outer body 1710. The outer body 1710 includes an interaction member recess 1720 which contains a first to fourth interaction members 1721 to 1724 in the form of rollers. The interaction member recess 1720 also includes a biasing spring 1725. The interaction member recess includes a straight cam portion associated with each interaction member, and the mode of operation for allowing the inner body 1730 to rotate relative to the outer body 1710 in only one direction will be understood by inference from the above described embodiments. The inner member 1730 has an inner surface 1732 suitable for receiving a hexagonal fastener such as a nut or bolt-head.

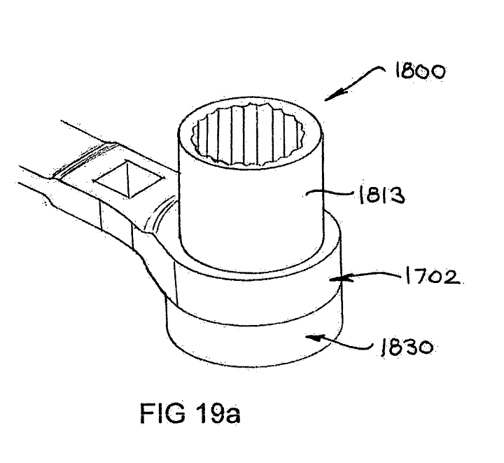

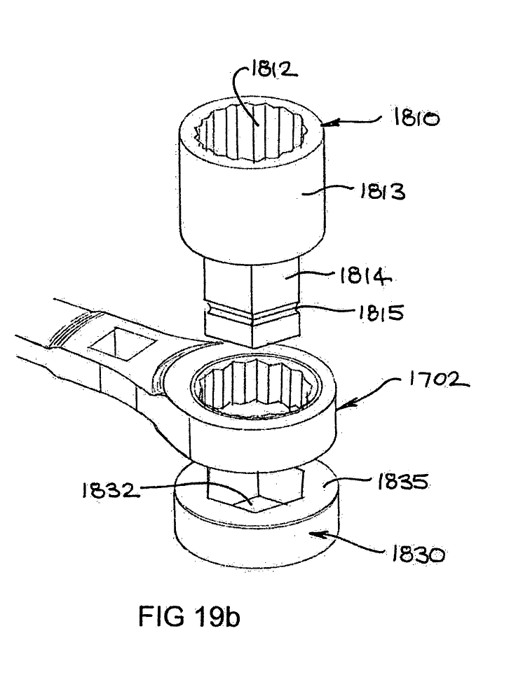

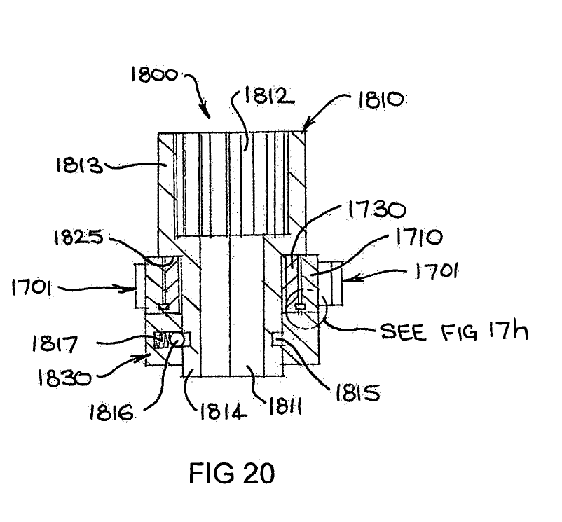

As best seen in FIGS. 17c and 17d, as well as FIGS. 19a and 19b which are enlarged details of FIGS. 17c and 17d, in a preferred embodiment the combination spanner 1700 is provided with an adaptor socket, generally designated 1800. The adaptor socket 1800 consists of two separate elements, namely a socket element 1810 and a securing element 1830. The socket element 1810 has a bore extending therethrough. The bore includes a narrower portion 1811 which is generally circular in cross-section and a wider portion 1812 defined by a wall with an internal surface having, in cross-sectional view, a shape with twenty-four sides defining twelve apexes in a form which will be recognised by those skilled in the art as being suitable for receiving hexagonal nuts and the like. Defining the wider portion of the bore is a generally cylindrical socket wall portion 1813 which has a generally cylindrical outer surface. The socket wall portion 1813 and wider portion 1812 of the bore constitute a driving portion for driving a fastener. Defining the narrower portion 1811 of the bore, is an interaction wall portion 1814 with an outer surface which has a generally hexagonal radial cross-section. The outer surface of the interaction wall portion 1814 is dimensioned to be a good fit with the inner surface 1732 of the inner body 1730. The interaction wall portion thus provides a hand tool interaction portion for engagement with the combination spanner 1700 but which could also be used with any other suitably sized and shaped hand tool, and in particular a ring spanner. The hand tool interaction portion has sufficient axial length to extend through the driving (or ring) part of a ring spanner and to project on the opposite side of the ring to the side from which the driving portion extends. Towards the distal end of the interaction portion, there is provided an annular groove 1815, in the interaction wall portion 1814 which acts as a connection portion. The adaptor socket 1800 further includes a securing element 1830 which is adapted to secure the socket portion 1810 in position in relation to a hand tool and in particular to prevent inadvertent withdrawal and separation of the interaction portion from the ring. The securing portion 1830 has a through bore 1832 which is hexagonal in radial cross-section allowing the interaction bore portion to fit therein. Provided in the internal surface 1833 of the securing member 1830 which defines the bore 1832 is one or more biased retention members, in this case in the form of a ball detent 1816 biased by a spring 1817 to be resiliently engageable into the groove 1815 in order to securely connect to the securing member 1830 to the interaction wall portion 1814 of the socket member 1810. It will be appreciated that the securing member 1830 has a radially extending shoulder portion 1835 which, in use, abuts a first radially extending outer surface of a ring spanner (or, in the illustrated embodiment, a first radially extending surface of the outer body 1710). Furthermore, the transition between the socket wall portion 1813 and the interaction wall portion 1814 of the socket member 1810 provides a radially extending surface 1825 which, in use, abuts a second radially extending surface of a ring spanner (or outer body 1710). Thus, in use, the adaptor socket 1800 may be fitted to the torque transmission mechanism 1702 of the combination spanner 1700 in a secure and attractive manner, as illustrated best in FIG. 19a.

It will be appreciated that the adaptor socket 1800 can effectively convert a combination spanner (or a ring spanner) having a one-way torque transmission mechanism, into a socket handle with a one-way torque transmission mechanism. Furthermore, the adaptor socket 1800 allows a standard ring spanner to be used as a socket handle.

In the illustrated embodiment, the adaptor socket provides a twelve apex socket for driving a hexagonal fastener and includes a through bore which extends all the way therethrough. Providing such a through bore allows fasteners to be operated on shafts of arbitrary length without restricting operation of fasteners to a position adjacent an end of a threaded shaft, as is the case with closed-end sockets. In an alternative embodiment, where a through bore is not required, the socket adaptor could provide a square drive block instead of a twelve apex socket. This would allow connection to any of a number of sockets or other fastener driving tools. In the illustrated embodiment, the size of socket is the same as the size of ring spanner used, but it will be appreciated that socket adaptors which provide different sized sockets could be used to increase or decrease the size of the drive. A number of socket adaptors could be provided in order to allow operation of a range of sizes of fastener.

It will further be appreciated that in this preferred embodiment, the direction of drive to be applied may be reversed by attaching the adaptor socket to the other side of the combination spanner.

Although the invention has been described with reference to particular examples, it will be appreciated by those skilled in the art that aspects of the invention may be embodied in many other forms.

It will be appreciated that there are many different embodiments and variations which can be made to the above described embodiments without departing from the scope of the invention. Torque transmission mechanisms in accordance with the present invention could be used in most, if not all applications, including tool heads, where torque transmission mechanisms based on ratchet and pawl systems are currently employed. Although it is desirable to use a small number of moving parts, both for economy and to avoid undue friction in the free-running state, a larger number of components than is in the described embodiments could be used. Any suitable number of larger and/or smaller cylindrical rollers could be used. Also, any suitable number of spherical rollers could be provided, to act as stop members. Although helical springs are specified in the above embodiment, other forms of biasing member could be used to bias the rollers, or indeed embodiments and variations in which biasing members are not required are possible. Similarly, although square cross-section bores and square cross-section drive blocks or elements are generally described, other cross-sectional shapes could be used.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art, in Australia or in any other country.

Modifications and improvements may be incorporated without departing from the scope of the present invention.

The claims defining the invention are as follows:

1. A torque transmission mechanism comprising:
an outer body having an inner surface defining a cavity therein;
an inner body having an outer surface, the inner body being located at least partially inside the cavity and able, in use, to rotate therein;
a plurality of rollers each located between the outer body and the inner body;
wherein there is provided one or more cam surfaces;
wherein rotation of the inner body relative to the outer body in a first direction is substantially unimpeded by the rollers, but rotation of the inner body in the opposite second direction is prevented or impeded by interaction of at least two rollers with said one or more cam surfaces;
wherein one of the rollers which interact with the one or more cam surfaces is a larger roller which is of a larger diameter than at least one other smaller roller which interacts with one of the one or more cam surfaces;
wherein one of the outer body and the inner body is formed with a recess therein, and the larger roller is located in said recess; and
wherein the body in which the recess is formed has a shape which, excluding the effect of the recess, has a non-uniform wall thickness, and the part of the body in which the recess is formed includes a part with a greater wall thickness excluding the effect of the recess.

2. A tool including a head wherein the head includes or consists of a torque transmission mechanism as claimed in claim 1.

3. A tool including a one-way torque transmission mechanism in a head thereof, which in use imparts torque from a driving portion to a drive element thereof, wherein said tool includes an attachment portion for attachment of a drive element of another tool, so that the drive element of the other tool may be forced so as to impart torque to the drive element of said tool.

4. A torque transmission mechanism comprising:
an outer body having a cavity therein;
an inner body located at least partially within the cavity;
a mechanism for controlling relative rotation of the inner body and outer body so that, in use, rotation of the inner body relative to the outer body in the first direction may be substantially unimpeded, but rotation of the inner body relative to the outer body in the opposite second direction is prevented or impeded;
wherein a cover is provided which extends between the inner body and the outer body, said cover being, in use, substantially fixed relative to the outer body; and
wherein one or more seals are provided between the inner body and the cover so as to isolate the mechanism for controlling relative rotation of the inner body and the outer body, from the exterior of the tool.

5. A torque transmission mechanism comprising:
an outer body having an inner surface defining a cavity therein;
an inner body having an outer surface, the inner body being located at least partially inside the cavity and able, in use, to rotate therein;
a plurality of rollers each located between the outer body and the inner body;
wherein there is provided one or more cam surfaces;
wherein rotation of the inner body relative to the outer body in a first direction is substantially unimpeded by the rollers, but rotation of the inner body in the opposite second direction is prevented or impeded by interaction of at least two rollers with said one or more cam surfaces;
wherein at least one of the rollers which interact with the one or more cam surfaces is a larger roller which is of a larger diameter than at least one other smaller roller which interacts with one of the one or more cam surfaces;
wherein the interaction of the rollers with the cam surface(s) which corresponds to prevention or impeding of the rotation in the second direction corresponds to each of the rollers being forcibly engaged between the inner and outer bodies so as to transmit torque between said inner and outer bodies; and
wherein as the mechanism changes from a state in which the rollers are not forcibly engaged between the inner and outer bodies to a state in which the rollers are forcibly engaged between the inner and out bodies, the rollers do not all become forcibly engaged between the inner and outer bodies simultaneously.

6. A tool including a head, wherein the head includes or consists of a torque transmission mechanism comprising:
an outer body having an inner surface defining a cavity therein;
an inner body having an outer surface, the inner body being located at least partially inside the cavity and able, in use, to rotate therein;
a plurality of rollers each located between the outer body and the inner body;
wherein rotation of the inner body relative to the outer body in a first direction is substantially unimpeded by the rollers, but rotation of the inner body in the opposite second direction is prevented or impeded by interaction of at least two rollers with the inner and outer bodies; and
wherein at least one of the rollers has a larger diameter than at least one other roller.

7. A torque transmission mechanism comprising:
an outer body having an inner surface defining a cavity therein;
an inner body having an outer surface, the inner body being located at least partially inside the cavity and able, in use, to rotate therein;
a plurality of rollers each located between the outer body and the inner body;
wherein rotation of the inner body relative to the outer body in a first direction is substantially unimpeded by the rollers, but rotation of the inner body in the opposite second direction is prevented or impeded by interaction of at least two rollers with the inner and outer bodies; and
wherein at least one of the rollers is generally spherical.
